(19) United States
(12) Patent Application Publication
(10) Pub. No.: US 2023/0306240 A1
(43) Pub. Date: Sep. 28, 2023

(54) PROCESSING METHOD IN A CONVOLUTIONAL NEURAL NETWORK ACCELERATOR, AND ASSOCIATED ACCELERATOR

(71) Applicant: COMMISSARIAT A L’ENERGIE ATOMIQUE ET AUX ENERGIES ALTERNATIVES, Paris (FR)

(72) Inventors: Hana KRICHENE, GIF SUR YVETTE (FR); Jean-Marc PHILIPPE, GIF SUR YVETTE (FR)

(21) Appl. No.: 18/122,665

(22) Filed: Mar. 16, 2023

(30) Foreign Application Priority Data
Mar. 23, 2022 (FR) 2202559

(51) Int. Cl. G06N 3/0464

(52) U.S. Cl. CPC G06N 3/0464

(57) ABSTRACT

A processing method in a convolutional neural network accelerator includes an array of unitary processing blocks associated with a set of respective local memories and performing computing operations on data stored in its local memories, wherein: during respective processing cycles, some unitary blocks receive and/or transmit data from or to neighbouring unitary blocks in at least one direction selected, on the basis of the data, from among the vertical and horizontal directions in the array; during the same cycles, some unitary blocks perform a computing operation in relation to data stored in their local memories during at least one previous processing cycle.

### CROSS-REFERENCE TO RELATED APPLICATION

This application claims priority to foreign French patent application No. FR 2202559, filed on Mar. 23, 2022, the disclosure of which is incorporated by reference in its entirety.

### FIELD OF THE INVENTION

The invention lies in the field of artificial intelligence and deep neural networks, and more particularly in the field of accelerating inference computing by convolutional neural networks.

### BACKGROUND

Artificial intelligence (AI) algorithms at present constitute a vast field of research, as they are intended to become essential components of next-generation applications, based on intelligent processes for making decisions based on knowledge of their environment, in relation for example to detecting objects such as pedestrians for a self-driving car or activity recognition for a health tracker smartwatch. This knowledge is gathered by sensors associated with very high-performance detection and/or recognition algorithms.

In particular, deep neural networks (DNN) and, among these, especially convolutional neural networks (CNN—see for example Y. Lecun et al. 1998. Gradient-based learning applied to document recognition. Proc. IEEE 86, 11 (November 1998), 2278-2324) are good candidates for being integrated into such systems due to their excellent performance in detection and recognition tasks. They are based on filter layers that perform feature extraction and then classification. These operations require a great deal of computing and memory, and integrating such algorithms into the systems requires the use of accelerators. These accelerators are electronic devices that mainly compute multiply-accumulate (MAC) operations in parallel, these operations being numerous in CNN algorithms. The aim of these accelerators is to improve the execution performance of CNN algorithms so as to satisfy application constraints and improve the energy efficiency of the system. They are based mainly on a high number of processing elements involving operators that are optimized for executing MAC operations and a memory hierarchy for effectively storing the data.

The majority of hardware accelerators are based on a network of elementary processors (or processing elements—PE) implementing MAC operations and use local buffer memories to store data that are frequently reused, such as filter parameters or intermediate data. The communications between the PEs themselves and those between the PEs and the memory are a highly important aspect to be considered when designing a CNN accelerator. Indeed, CNN algorithms have a high intrinsic parallelism along with possibilities for reusing data. The on-chip communication infrastructure should therefore be designed carefully so as to utilize the high number of PEs and the specific features of CNN algorithms, which make it possible to improve both performance and energy efficiency. For example, the multicasting or broadcasting of specific data in the communication network will allow the target PEs to simultaneously process various data with the same filter using a single memory read operation.

Many factors have contributed to limiting or complicating the scalability and the flexibility of CNN accelerators existing on the market. These factors are manifested by: (i) a limited bandwidth linked to the absence of an effective broadcast medium, (ii) excess consumption of energy linked to the size of the memory (for example 40% of energy consumption in some architectures is induced by the memory) and to the memory capacity wall problem (iii) and also limited reuse of data and a need for an effective medium for processing various communication patterns.

There is therefore a need to increase processing efficiency in neural accelerators of CNN architectures, taking into account the high number of PEs and the specific features of CNN algorithms.

### SUMMARY OF THE INVENTION

To this end, according to a first aspect, the present invention describes a processing method in a convolutional neural network accelerator comprising an array of unitary processing blocks, each unitary processing block comprising a unitary computing element PE associated with a set of respective local memories and performing computing operations from among multiplications and accumulations on data stored in its local memories said method comprising the following steps:
during respective processing cycles clocked by a clock of the accelerator, some unitary blocks of the array receive and/or transmit data from or to neighbouring unitary blocks in the array in at least one direction selected, on the basis of said data, from among at least the vertical and horizontal directions in the array;
during said same cycles, some unitary blocks of the array perform one of said computing operations in relation to data stored in their set of local memories during at least one previous processing cycle.

Such a method makes it possible to guarantee flexible processing and to reduce energy consumption in CNN architectures comprising an accelerator.

It offers a DataFlow execution model that distributes, collects and updates, from among the numerous distributed processing elements (PE), the operands and makes it possible to ensure various degrees of parallelism on the various types of shared data (weight, Ifmaps and Psum) in CNNs, to reduce the cost of data exchanges without degrading performance and finally to facilitate the processing of various CNN networks and of various layers of one and the same network (Conv2D, FC, PW, DW, residual, etc.).

In some embodiments, such a method will furthermore comprise at least one of the following features:
at least during one of said processing cycles:
at least one unitary block of the array receives data from multiple neighbouring unitary blocks in the array that are located in different directions with respect to said unitary block; and/or
at least one unitary block of the array transmits data to multiple neighbouring unitary blocks in the array in different directions;
a unitary block performs transmission of a type selected between broadcast and multicast on the basis of a header of the packet to be transmitted and the unitary block applies at least one of said rules:
for a packet to be transmitted in broadcast mode from a neighbouring block located in a given direction with respect to said block having to perform the transmission, said block transmits the packet in the course of a cycle in all directions except for that of said neighbouring block;
for a packet to be transmitted in multicast mode: if the packet comes from the PE of the unitary block, the multicast implemented by the block is bidirectional; if not, the multicast implemented by the block is unidirectional, directed opposite to the neighbouring processing block from which said packet originates;
the data receptions and/or transmissions implemented by a unitary processing block are implemented by a routing block contained within said unitary block, implementing parallel data routing functions during one and the same processing cycle, on the basis of communication directions associated with the data;
in the case of at least two simultaneous transmission requests in one and the same direction by a unitary block during a processing cycle, the priority between said requests is arbitrated, the request arbitrated as having priority is transmitted in said direction and the other request is stored and then transmitted in said direction in a subsequent processing cycle.

According to another aspect, the invention describes a convolutional neural accelerator comprising an array of unitary processing blocks and a clock, each unitary processing block comprising a unitary computing element PE associated with a set of respective local memories and designed to perform computing operations from among multiplications and accumulations on data stored in its local memories
wherein some unitary blocks of the array are designed, during respective processing cycles clocked by the clock of the accelerator, to receive and/or transmit data from or to neighbouring unitary blocks in the array in at least one direction selected, on the basis of said data, from among at least the vertical and horizontal directions in the array;
and some unitary blocks of the array are designed, during said same cycles, to perform one of said computing operations in relation to data stored in their set of local memories during at least one previous processing cycle.

In some embodiments, such an accelerator will furthermore comprise at least one of the following features:
at least during one of said processing cycles:
at least one unitary block of the array is designed to receive data from multiple neighbouring unitary blocks in the array that are located in different directions with respect to said unitary block; and/or
at least one unitary block of the array is designed to transmit data to multiple neighbouring unitary blocks in the array in different directions;
a unitary block is designed to perform transmission of a type selected between broadcast and multicast on the basis of a header of the packet to be transmitted and the unitary block is designed to apply at least one of said rules:
for a packet to be transmitted in broadcast mode from a neighbouring block located in a given direction with respect to said block having to perform the transmission, said block transmits the packet in the course of a cycle in all directions except for that of said neighbouring block;
for a packet to be transmitted in multicast mode: if the packet comes from the PE of the unitary block, the multicast implemented by the block is bidirectional; if not, the multicast implemented by the block is unidirectional, directed opposite to the neighbouring processing block from which said packet originates;
a unitary block comprises a routing block designed to implement said data receptions and/or transmissions performed by the unitary block, said routing block being designed to implement parallel data routing functions during one and the same processing cycle, on the basis of communication directions associated with the data;
in the case of at least two simultaneous transmission requests in one and the same direction by a unitary block during a processing cycle, the routing block of the unitary block is designed to arbitrate priority between said requests, the request arbitrated as having priority then being transmitted in said direction and the other request being stored and then transmitted in said direction in a subsequent processing cycle.

### BRIEF DESCRIPTION OF THE DRAWINGS

The invention will be better understood and other features, details and advantages will become more clearly apparent on reading the following non-limiting description, and by virtue of the appended figures, which are given by way of example.

FIG. 1 shows a neural network accelerator in one embodiment of the invention;

FIG. 2 shows a unitary processing block in one embodiment of the invention;

FIG. 3 shows a method in one embodiment of the invention;

FIG. 4 shows the structure of communication packets in the accelerator in one embodiment;

FIG. 5 shows a routing block in one embodiment of the invention;

FIG. 6 outlines the computing control and communication architecture in one embodiment of the invention;

FIG. 7 illustrates a stage of convolution computations;

FIG. 8 illustrates another stage of convolution computations;

FIG. 9 shows another stage of convolution computations;

FIG. 10 illustrates step 101 of the method of FIG. 3;

FIG. 11 illustrates step 102 of the method of FIG. 3;

FIG. 12 illustrates step 103 of the method of FIG. 3.

Identical references may be used in different figures to designate identical or comparable elements.

### DETAILED DESCRIPTION

A CNN comprises various types of successive neural network layers, including convolution layers, each layer being associated with a set of filters. A convolution layer analyses, by zones, using each filter (by way of example: horizontal Sobel, vertical Sobel, etc. or any other filter under consideration, notably resulting from training) of the set of filters, at least one data matrix that is provided thereto at input, called Input Feature Map (also called IN hereinafter) and delivers, at output, at least one data matrix, here called Output Feature Map (also called OUT hereinafter), which makes it possible to keep only what is sought in accordance with the filter under consideration.

The matrix IN is a matrix of n rows and n columns. A filter F is a matrix of p rows and p columns. The matrix OUT is a matrix of m rows and m columns. In some specific cases, m=n−p+1, in the knowledge that the exact formula is:
m=(n−f+2p)/s+1, where
m: ofmap (m×m)—the size might not be regular
n: ifmap (n×n)—the size might not be regular
f: filter (f×f)
p: 0-padding
s: stride.
For example, p=3 or 5 or 9 or 11.

As is known, the convolutions that are performed correspond for example to the following process: the filter matrix is positioned in the top left corner of the matrix IN, a product of each pair of coefficients thus superimposed is calculated; the set of products is summed, thereby giving the value of the pixel (1,1) of the output matrix OUT. The filter matrix is then shifted by one cell (stride) horizontally to the right, and the process is reiterated, providing the value of the pixel (1,2) of the matrix OUT, etc. Once it has reached the end of a row, the filter is dropped vertically by one cell, the process is reiterated starting again from the right, etc. until having run through the entire matrix IN.

Convolution computations are generally implemented by neural network computing units, also called artificial intelligence accelerators or NPU (Neural Processing Unit), comprising a network of processor elements PE.

In one example, one example of a computation conventionally performed in a convolution layer implemented by an accelerator is presented below.

Consideration is given to the filter F consisting of the following weights:

TABLE 1

| | | |
|---|---|---|
| f₁ | f₂ | f₃ |
| f₄ | f₅ | f₆ |
| f₇ | f₈ | f₉ |

Consideration is given to the following matrix IN:

TABLE 2

| | | | | |
|---|---|---|---|---|
| in₁ | in₂ | in₃ | in₄ | in₅ |
| in₆ | in₇ | in₈ | in₉ | in₁₀ |
| in₁₁ | in₁₂ | in₁₃ | in₁₄ | in₁₅ |
| in₁₆ | in₁₇ | in₁₈ | in₁₉ | in₂₀ |
| in₂₁ | in₂₂ | in₂₃ | in₂₄ | in₂₅ |

And consideration is given to the following matrix OUT:

TABLE 3

| | | |
|---|---|---|
| out₁ | out₂ | out₃ |
| out₄ | out₅ | out₆ |
| out₇ | out₈ | out₉ |

The expression of each coefficient of the matrix OUT is a weighted sum corresponding to an output of a neuron of which inᵢ would be the inputs and fⱼ would be the weights applied to the inputs by the neuron and which would compute the value of the coefficient.

Consideration will now be given to an array of unitary computing elements pe, comprising as many rows as the filter F (p=3 rows) and as many columns as the matrix OUT has rows (m=3): [pei,j] i=0 to 2 and j=0 to 2. The following is one exemplary use of the array to compute the coefficients of the matrix OUT.

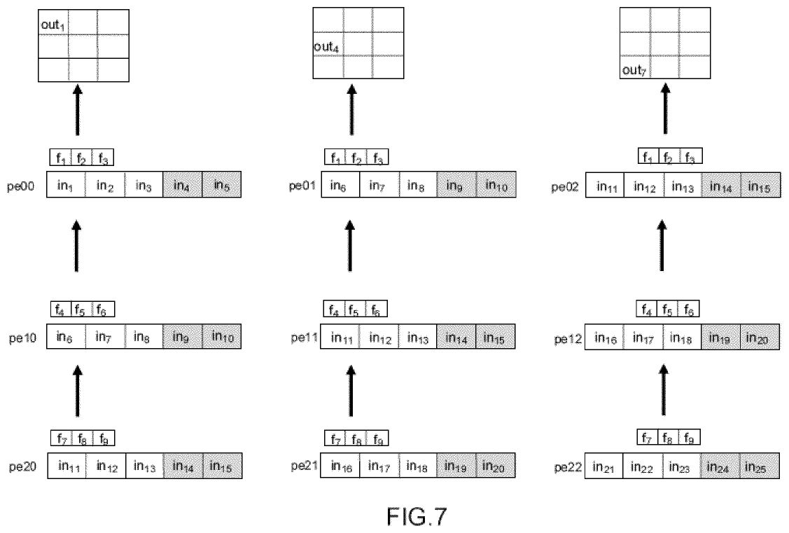

As shown in FIG. 7, the (i+1)th row of the filter matrix, i=0 to 2, is provided to each coefficient of the (i+1)th row of the pe. The matrix IN is then provided to the array of pe: the first row of IN is thus provided to the unitary computing element pe00, the second row of IN is provided to the coefficients pe10 and pe01, located on one and the same diagonal; the third row of IN is provided to the unitary elements pe20, pe11 and pe02, located on one and the same diagonal; the fourth row of IN is provided to the elements pe21 and pe12 on one and the same diagonal, and the fifth row of IN is provided to pe22.

In a first computing salvo also shown in FIG. 7, a convolution (combination of multiplications and sums) is performed in each pe between the filter row that was provided thereto and the first p coefficients of the row of the matrix IN that was provided thereto, delivering a named partial sum (the greyed-out cells in the row of IN are not used for the current computation). pe00 thus computes f1.in1+f2.in2+f3.in3 etc. Next, the three partial sums determined by the pe of one and the same column are summed progressively: the partial sum determined by pe2j is provided to pe1j, which adds it to the partial sum that it computed beforehand, this new partial sum resulting from the accumulation is then in turn provided by pe1j to pe0j, which adds it to the partial sum that it had computed, j=0 to 2: the total thus obtained is equal to the first coefficient of the j+1^{th} row of the matrix OUT.

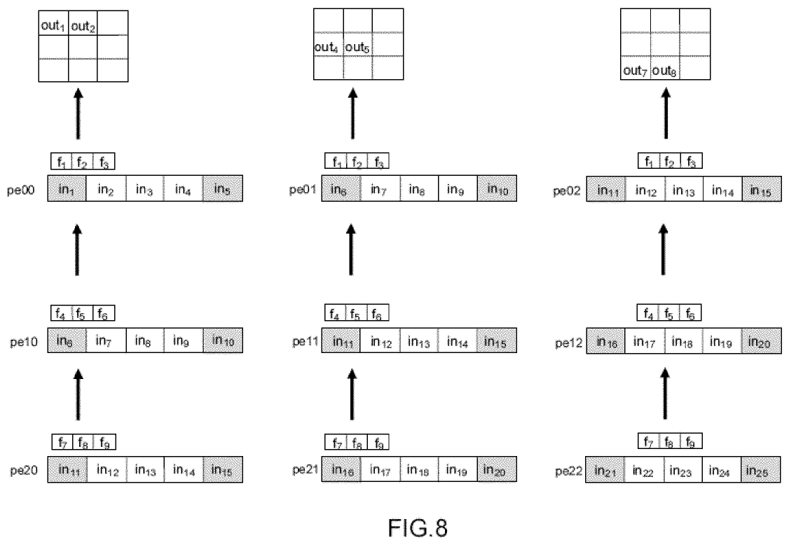

In a second computing salvo shown in FIG. 8, a convolution is performed in each pe between the filter row that was provided thereto and the p=3 coefficients, starting from the 2^{nd} coefficient, of the row of the matrix IN that was provided thereto, delivering a partial sum. pe00 thus computes f1.in2+f2.in3+f3.in4 etc. Next, the three partial sums determined by the pe of one and the same column are summed progressively as described above and the total thus obtained is equal to the second coefficient of the j+1^{th} row of the matrix OUT.

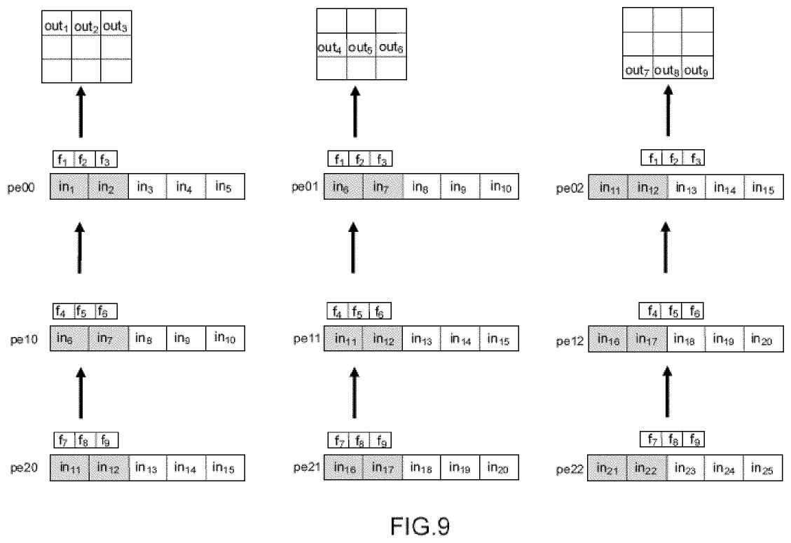

In a third computing salvo shown in FIG. 9, a convolution is performed in each pe between the filter row that was provided thereto and the p=3 coefficients, starting from the 3^{rd} coefficient, of the row of the matrix IN that was provided thereto, delivering a named partial sum. pe00 thus computes f1.in3+f2.in4+f3.in5 etc. Next, the three partial sums determined by the pe of one and the same column are summed progressively as described above and the total thus obtained is equal to the third coefficient of the j+1^{th} row of the matrix OUT.

In the computing process described here by way of example, the ith row of the pes thus makes it possible to successively construct the ith column of OUT, i=1 to 3.

It emerges from this example that the manipulated data rows (weights of the filters, weights of the Input Feature Map and partial sums) are spatially reused between the unitary processor elements: here for example the same filter data are used by the pe of one and the same horizontal row and the same IN data are used by all of the pe of diagonal rows, whereas the partial sums are transferred vertically and then reused.

It is therefore important that the communications of these data and the computations involved are carried out in a manner optimized in terms of transfer time and of computing access to the central memory initially delivering these data, specifically regardless of the dimensions of the input data and output data or the computations that are implemented.

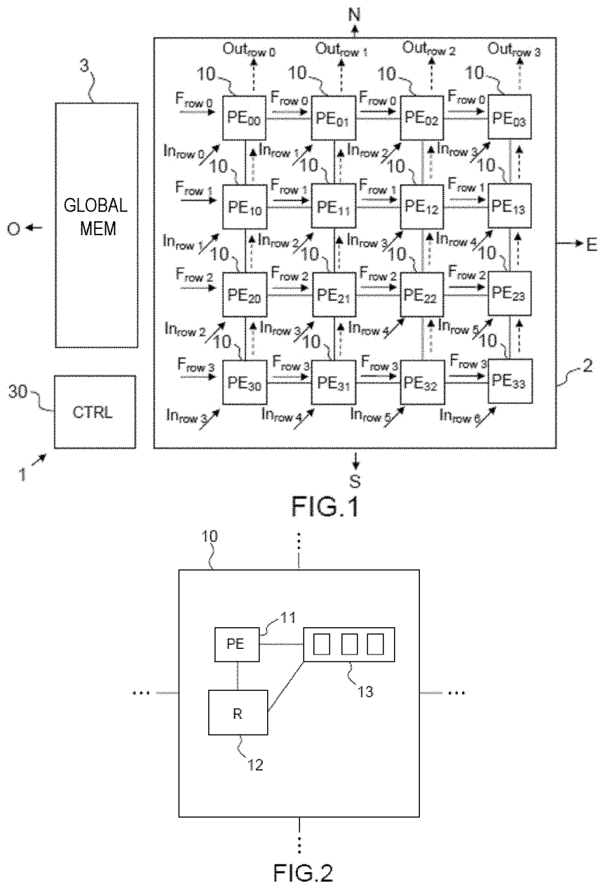

To this end, with reference to FIG. 1, a CNN neural network accelerator 1 in one embodiment of the invention comprises an array 2 of unitary processing blocks 10, a global memory 3 and a control block 30.

The array 2 of unitary processing blocks 10 comprises unitary processing blocks 10 arranged in a network, connected by horizontal and vertical communication links allowing data packets to be exchanged between unitary blocks, for example in a matrix layout of N rows and M columns.

The accelerator 1 has for example an architecture based on an NoC (Network on Chip).

In one embodiment, each processing block 10 comprises, with reference to FIG. 2, a processor PE (processing element) 11 designed to carry out computing operations, notably MAC ones, a set of memories 13, comprising for example multiple registers, intended to store filter data, Input Feature Map input data received by the processing block 10 and results (partial sums, accumulations of partial sums) computed by the PE 11 notably, and a router 12 designed to route incoming or outgoing data communications.

A unitary processing block 10 (and similarly its PE) is referenced by its row and column rank in the array, as shown in FIGS. 1, 10, 11 and 12. The processing block 10 (i,j), comprising the PEᵢⱼ 11, is thus located on the i+1th row and j+1th column of the array 2, i=0 to 3 and j=0 to 3.

Each processing block 10 not located on the edge of the network thus comprises 8 neighbouring processing blocks 10, in the following directions: one to the north (N), one to the south (S), one to the west (W), one to the east (E), one to the north-east, one to the north-west, one to the south-east, and one to the south-west.

The control block 30 is designed to synchronize with one another the computing operations in the PE and the data transfer operations between unitary blocks 10 or within unitary blocks 10 and implemented in the accelerator 1. All of these processing operations are clocked by a clock of the accelerator 1.

There will have been a preliminary step of configuring the array 2 to select the set of PE to be used, among the available PE of the maximum hardware architecture of the accelerator 1, for applying the filter under consideration of a layer of the neural network to a matrix IN. In the course of this configuration, the number of “active” rows of the array 2 is set to be equal to the number of rows of the filter (p) and the number of “active” columns of the array 2 is taken to be equal to the number of rows of the matrix OUT (m). In the case shown in FIGS. 1, 10, 11 and 12, these numbers p and m are equal to 4 and the number n of rows of the matrix IN is equal to 7.

The global memory 3, for example a DRAM external memory or SRAM global buffer memory, here contains all of the initial data: the weights of the filter matrix and the input data of the Input Feature Map matrix to be processed. The global memory 3 is also designed to store the output data delivered by the array 2, in the example under consideration, by the PE at the north edge of the array 2. A set of communication buses (not shown) for example connects the global memory 3 and the array 2 in order to perform these data exchanges.

Hereinafter and in the figures, the set of data of the (i+1)th row of the weights in the filter matrix is denoted F_{rowi}, i=0 to p−1, the set of data of the (i+1)th row of the matrix IN is denoted in_{rowi}, i=0 to n−1, the data resulting from computing partial sums carried out by PEᵢⱼ is denoted psumᵢⱼ, i=0 to 3 and j=0 to 3.

The arrows in FIG. 1 show the way in which the data are reused in the array 2. Specifically, the rows of one and the same filter, F_{rowi}, i=0 to p−1, are reused horizontally through the PEs (this is therefore a horizontal multicast of the weights of the filter), the rows in_{rowi} of IN, i=0 to n−1, are reused diagonally through the PEs (a diagonal multicast of the input image, implemented here by the sequence of a horizontal multicast and a vertical multicast) and the partial sums psum are accumulated vertically through the PEs (this is a unicast of the psum), as shown by the dashed vertical arrows.

During the computing of deep CNNs, each datum may be utilized numerous times by MAC operations implemented by the PEs. Repeatedly loading these data from the global memory 3 would introduce an excessive number of memory access operations. The energy consumption of access operations to the global memory may be far greater than that of logic computations (MAC operation for example). Reusing data of the processing blocks 10 permitted by the communications between the blocks 10 of these data in the accelerator 1 makes it possible to limit access operations to the global memory 3 and thus reduce the induced energy consumption.

The accelerator 1 is designed to implement, in the inference phase of the neural network, the parallel reuse, described above, by the PE, of the three types of data, i.e. the weights of the filter, the input data of the Input Feature Map matrix and the partial sums, and also the computational overlapping of the communications, in one embodiment of the invention.

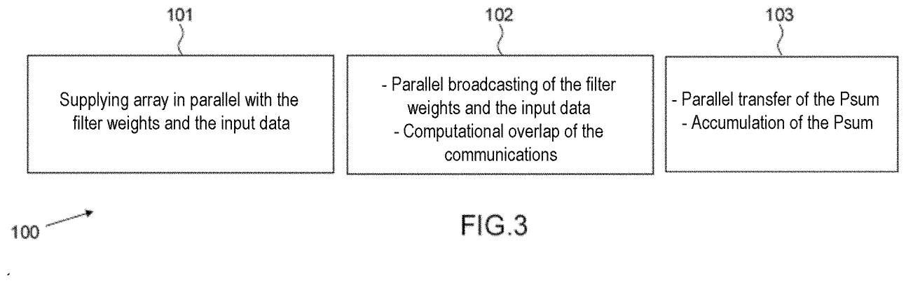

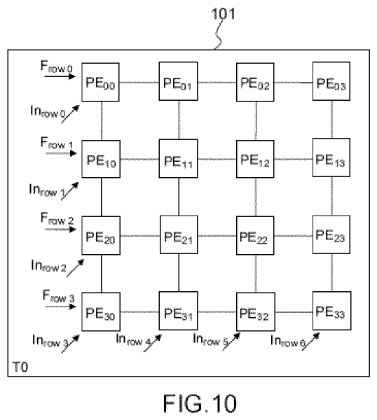

The accelerator 1 is designed notably to implement the steps described below of a processing method 100, with reference to FIG. 3 and to FIGS. 10, 11, 12.

In a step 101, with reference to FIGS. 3 and 10, the array 2 is supplied in parallel with the filter weights and the input data of the matrix IN, via the bus between the global memory 3 and the array 2.

Thus, in processing cycle TO (the cycles are clocked by the clock of the accelerator 1):
the first column of the array 2 is supplied by the respective rows of the filter: the row of weights F_{rowi}, i=0 to 3 is provided at input of processing block 10 (i, 0);
the first column and the last row of the array 2 are supplied by the respective rows of the Input Feature Map matrix: the row in_{rowi}, i=0 to 3 is provided at input of the processing block 10 (i, 0) and the row in_{rowi}, i=4 to 6 is provided at input of the processing block 10 (3, i−3).

In cycle T1 following cycle T0, the weights and data from the matrix IN received by each of these blocks 10 are stored in respective registers of the memory 13 of the block 10.

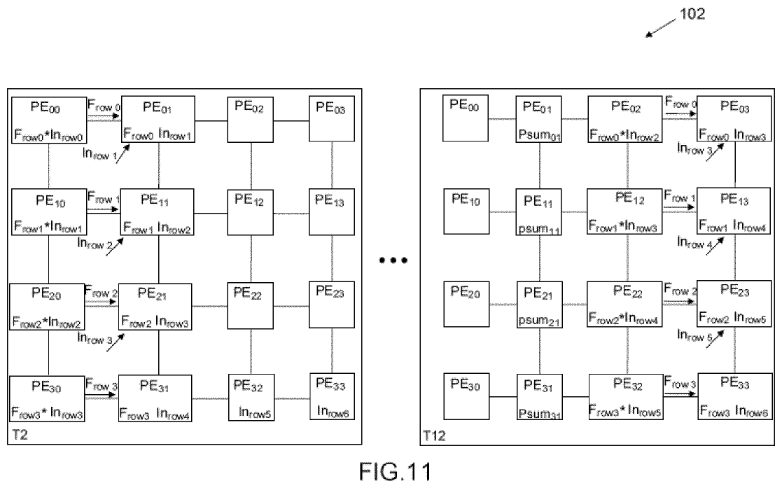

In a step 102, with reference to FIGS. 3 and 11, the broadcasting of the filter weights and of the input data within the network is iterated: it is performed in parallel, by horizontal multicasting of the rows of filter weights and diagonal multicasting of the rows of the Input Feature Map input image, as shown sequentially in FIG. 11 and summarized in FIG. 3.

Thus, in cycle T2:
the first column, by horizontal broadcasting, sends, to the second column of the array 2, the respective rows of the filter stored beforehand: the row of weights From, i=0 to 3, is provided at input of the processing block 10 (i, 1) by the processing block (i,0); and in parallel
each of the processing blocks 10 (i, 0) transmits the row in_{rowi}, i=1 to 3- and each of the processing blocks 10 (3, i−3) transmits the row in_{rowi}, i=4 to 6-to the processing block 10 neighbouring it in the NE direction (for example the block (3,0) transmits to the block (2,1)): to reach its destination, in the present case, to reach this neighbour, this will actually require carrying out two transmissions: a horizontal transmission and a vertical transmission (for example, in order for the data to pass from the block 10 (3,0) to the block 10 (2,1), it will go from the block (3,0) to the block (3,1), and then to the block (2,1): therefore first the neighbours to the east of the processing blocks 10 (i, 0), i=1 to 3 and the processing blocks 10 (3, i−3) first receive the row; the first column of processing blocks 10 having filter weights and input data of the matrix IN, the PE of these blocks implement a convolution computation between the filter and (at least some of) these input data; the partial sum result psum₀ⱼ thus computed by the PE₀ⱼ j=0 to 3, is stored in a register of the memory 13.

In cycle T3, the filter weights and data from the matrix IN received in T2 by these blocks 10 at T2 are stored in respective registers of the memory 13 of each of these blocks 10.

In cycle T4, in parallel:
the second column, by horizontal broadcasting, supplies, to the third column of the array 2, the respective rows of the filter stored beforehand: the row of weights F_{rowi}, i=0 to 3, is provided at input of the processing block 10 (i, 2) by the processing block (i,1);
the processing blocks 10 (i−1, 1) receive the row in_{rowi}, i=1 to 3 and each of the processing blocks 10 (2, i−2) receive the row in_{rowi}, i=4 to 5;
the second column of processing blocks 10 having filter weights and input data of the matrix IN, the PE of these blocks implement a convolution computation between the filter and (at least some of) these input data; the partial sum result psum₁ⱼ thus computed by the PE₁ⱼ, j=0 to 3, is stored in a register of the memory 13.

In cycle T5, the filter weights and data from the matrix IN received in T4 by
these blocks 10 are stored in respective registers of the memory 13 of each of these blocks 10.

In cycle T6, in parallel:
the third column, by horizontal broadcasting, supplies, to the fourth column of the array 2, the respective rows of the filter stored beforehand, thus completing the broadcasting of the filter weights in the array 2: the row of weights F_{rowi}, i=0 to 3, is provided at input of the processing block 10 (i, 3) by the processing block (i,2);
the processing blocks 10 having received a row of the matrix IN at the time T4 and having a neighbour in the NE direction in turn transmit this row of the matrix IN to this neighbour.

In cycle T7, the filter weights and data from the matrix IN received in T4 by these blocks 10 are stored in respective registers of the memory 13 of each of these blocks 10.

In cycle T8, the third column of processing blocks 10 having filter weights and input data of the matrix IN, the PE of these blocks implement a convolution computation between the filter and (at least some of) these input data; the partial sum result psum₂ⱼ thus computed by the PE₂ⱼ, j=0 to 3, is stored in a register of the memory 13.
the processing blocks 10 having received a row of the matrix IN at the time T6 and having a neighbour in the NE direction in turn transmit this row of the matrix IN to this neighbour.

The diagonal broadcasting continues.

In cycle T12, the block 10 (03) has in turn received the row in_{row3}.

The fourth column of processing blocks 10 having filter weights and input data of the matrix IN, the PE of these blocks implement a convolution computation between the filter and (at least some of) these input data; the partial sum result psum₃ⱼ thus computed by the PE₃ⱼ, j=0 to 3, is stored in a register of the memory 13.

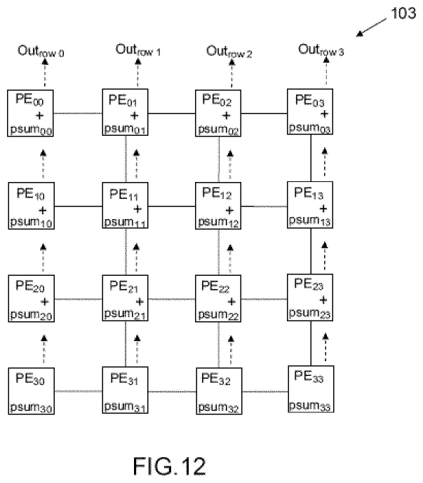

In a step 103, with reference to FIGS. 3 and 12, a parallel transfer of the partial sums psum is performed and these psums are accumulated: the processing blocks 10 and the last row of the array 2 each send the computed partial sum to their neighbour located in the north direction. Said neighbour accumulates this received partial sum with the one that it computed beforehand and in turn sends the accumulated partial sum to its north neighbour, which repeats the same operation, etc. until the processing blocks 10 of the first row of the array 2 have performed this accumulation (all of these processing operations being performed in a manner clocked by the clock of the accelerator 1). This last accumulation carried out by each processing block (0,j) j=0 to 3, corresponds to (some of the) data of the row j of the matrix OUT. It is then delivered by the processing block (0,j) to the global memory 3 for storage.

The Output Feature Maps results under consideration from the convolution layer are thus determined on the basis of the outputs Out_{rowi}, i=0 to 3.

As was demonstrated with reference to FIG. 3, the broadcasting of the filter weights is performed in the accelerator 1 (multicasting of the filter weights with horizontal reuse of the filter weights through the processing blocks 10) in parallel with the broadcasting of the input data of the matrix IN (multicasting of the rows of the image with diagonal reuse through the processing blocks 10).

Computationally overlapping the communications makes it possible to reduce the cost of transferring data while improving the execution time of parallel programs by reducing the effective contribution of the time dedicated to transferring data to the execution time of the complete application. The computations are decoupled from the communication of the data in the array so that the PE 11 perform computing work while the communication infrastructure (routers 12 and communication links) is performing the data transfer. This makes it possible to partially or fully conceal the communication overhead, in the knowledge that the overlap cannot be perfect unless the computing time exceeds the communication time and the hardware makes it possible to support this paradigm.

In the embodiment described above in relation to FIG. 3, it is expected that all of the psum are computed before they are accumulated. In another embodiment, the accumulation of the psum is launched on the first columns of the network even while the transfer of the filter data and the data of the matrix IN continues in the columns further to the east and therefore the psum for these columns have not yet been computed: there is therefore in this case an overlap of the communications by the communications of the partial sums psum, thereby making it possible to reduce the contribution of the data transfers to the total execution time of the application even further and thus improve performance. The first columns may then optionally be used more quickly for other memory storage operations and other computations, the global processing time thereby being further improved.

The operations have been described above in the specific case of an RS (Row Stationary) Dataflow and of a Conv2D convolutional layer (cf. Y. Chen ae al. 2017. Eyeriss: An Energy-Efficient Reconfigurable Accelerator for Deep Convolutional Neural Networks. IEEE Journal of Solid-State Circuits 52, 1 (November 2017), 127-138). However, other types of Dataflow execution (WS: Weight-Stationary Dataflow, IS: Input-Stationary Dataflow, OS: Output-Stationary Dataflow, etc.) involving other schemes for reusing data between PE, and therefore other transfer paths, other computing layouts, other types of CNN layers (Fully Connected, PointWise, depthWise, Residual) etc. may be implemented according to the invention: the data transfers of each type of data (filter, ifmap, psum), in order to be reused in parallel, should thus be able to be carried out in any one of the possible directions in the routers, specifically in parallel with the data transfers of each other type (it will be noted that some embodiments may of course use only some of the proposed options: for example, the spatial reuse of only a subset of the data types from among filter, Input Feature Maps, partial sums data).

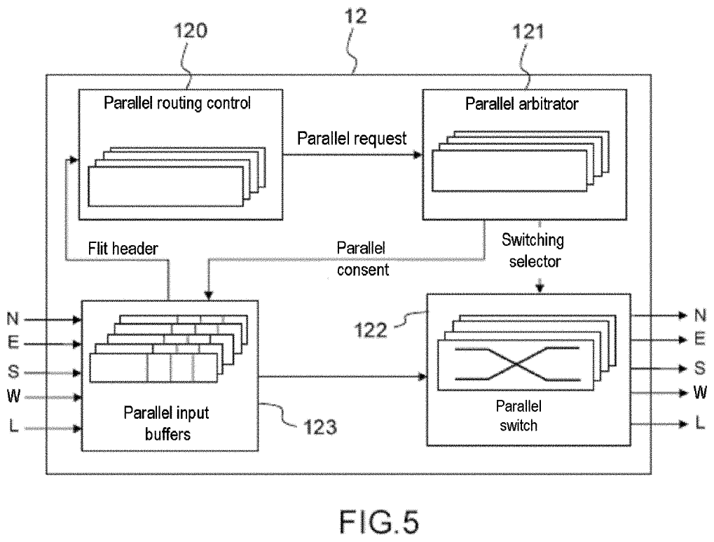

To this end, the routing device 12 comprises, with reference to FIG. 5, a block of parallel routing controllers 120, a block of parallel arbitrators 121, a block of parallel switches 122 and a block of parallel input buffers 123.

Specifically, through these various buffering modules (for example FIFO, first-in-first-out) of the block 123, various data communication requests (filters, IN data or psums) received in parallel (for example from a neighbouring block 10 to the east (E), to the west (W), to the north (N), to the south (S), or locally to the PE or the registers) may be stored without any loss.

These requests are then processed simultaneously in multiple control modules within the block of parallel routing controllers 120, on the basis of the Flit (flow control unit) headers of the data packets. These routing control modules deterministically control the data transfer in accordance with an XY static routing algorithm (for example) and manage various types of communication (unicast, horizontal, vertical or diagonal multicast, and broadcast).

The resulting requests transmitted by the routing control modules are provided at input of the block of parallel arbitrators 122. Parallel arbitration of the priority of the order of processing of incoming data packets, in accordance for example with the round-robin arbitration policy based on scheduled access, makes it possible to manage collisions better, that is to say a request that has just been granted will have the lowest priority on the next arbitration cycle. In the event of simultaneous requests for one and the same output (E, W, N, S), the requests are stored in order to avoid a deadlock or loss of data (that is to say two simultaneous requests on one and the same output within one and the same router 12 are not served in one and the same cycle). The arbitration that is performed is then indicated to the block of parallel switches 122.

The parallel switching simultaneously switches the data to the correct outputs in accordance with the Wormhole switching rule for example, that is to say that the connection between one of the inputs and one of the outputs of a router is maintained until all of the elementary data of a packet of the message have been sent, specifically simultaneously through the various communication modules for their respective direction N, E, S, W, L.

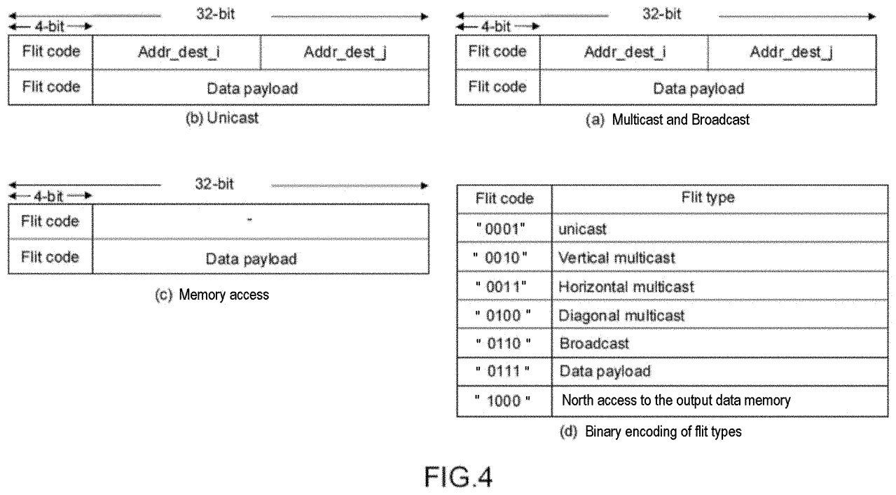

The format of the data packet is shown in FIG. 4. The packet is of configurable size W_{data} (32 bits in the figure) and consists of a header flit followed by payload flits. The size of the packet will depend on the size of the interconnection network, since the more the number of routers 11 increases, the more the number of bits for coding the addresses of the recipients or the transmitters increases. Likewise, the size of the packet varies with the size of the payloads (weights of the filters, input activations or partial sums) to be carried in the array 2. The value of the header determines the communication to be provided by the router. There are many types of possible communication: unicast, horizontal multicast, vertical multicast, diagonal multicast and broadcast, memory access 3. The router 11 first receives the control packet containing the type of the communication and the recipient or the source, identified by its coordinates (i,j) in the array, in the manner shown in FIG. 4. The router 11 decodes this control word and then allocates the communication path to transmit the payload data packet, which arrives in the cycle following the receipt of the control packet. The corresponding pairs of packets are shown in FIG. 4 (a, b, c). Once the payload data packet has been transmitted, the allocated path will be freed up to carry out further transfers.

In one embodiment, the router 12 is designed to prevent the return transfer during multicasting (multicast and broadcast communications), in order to avoid transfer loopback and to better control the transmission delay of the data throughout the array 2. Indeed, during the broadcast according to the invention, packets from one or more directions will be transmitted in the other directions, the one or more source directions being inhibited. This means that the maximum broadcast delay in a network of size N×M is equal to [(N−1)+(M−1)]. Thus, when a packet to be broadcast in broadcast mode arrives at input of a router 12 of a processing block 10 (block A) from a neighbouring block 10 located in a direction E, W, N or S with respect to the block A, this packet is returned in parallel in all directions except for that of said neighbouring block.

Moreover, in one embodiment, when a packet is to be transmitted in multicast mode (horizontal or vertical) from a processing block 10: if said block is the source thereof (that is to say the packet comes from the PE of the block), the multicast is bidirectional (it is performed in parallel to E and W fora horizontal multicast, to S and N for a vertical multicast); if not, the multicast is unidirectional, directed opposite to the neighbouring processing block 10 from which the packet originates.

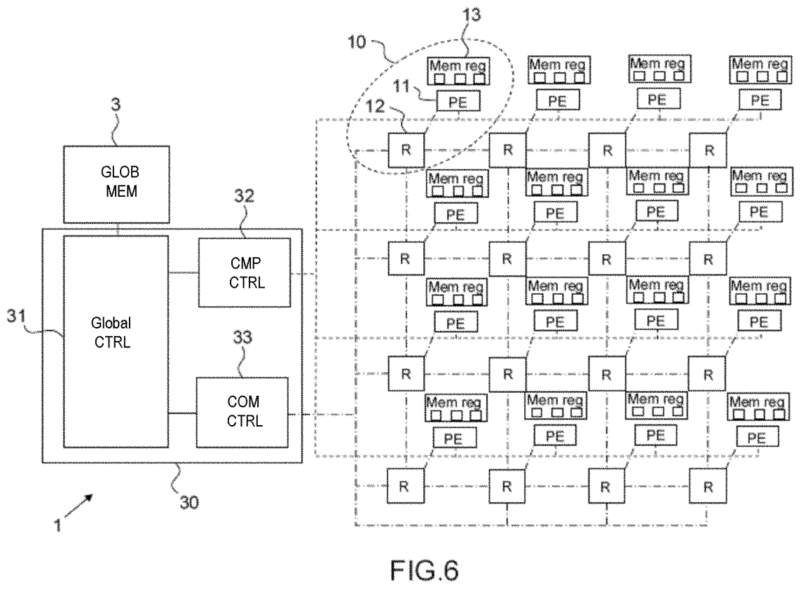

In one embodiment, in order to guarantee and facilitate the computational overlap of the communications, with reference to FIG. 6, the control block 30 comprises a global control block 31, a computing control block 32 and a communication control block 33: the communication control is performed independently of the computing control, while still keeping synchronization points between the two processes in order to facilitate simultaneous execution thereof.

The computing controller 32 makes it possible to control the multiply and accumulate operations, and also the read and write operations from and to the local memories (for example a register bank), while the communication controller 33 manages the data transfers from the global memory 3 and the local memories 13, and also the transfers of computing data between processing blocks 10. Synchronization points between the two controllers are implemented in order to avoid erasing or losing the data. With this communication control mechanism independent from that used for computation, it is possible to transfer the weights in parallel with the transfer of the data and execute communication operations in parallel with the computation. This thus manages to cover not only computational communication but also communication by way of another communication.

The invention thus proposes a solution for executing the data stream based on the computational overlap of communications in order to improve performance and on the reuse, for example configurable reuse, of the data (filters, input images and partial sums) in order to reduce multiple access operations to memories, making it possible to ensure flexibility of the processing operations and reduce energy consumption in specialized architectures of inference convolutional neural networks (CNN). The invention also proposes parallel routing in order to guarantee the features of the execution of the data stream by providing “any-to-any” data exchanges with broad interfaces for supporting lengthy data bursts. This routing is designed to support flexible communication with numerous multicast/broadcast requests with non-blocking transfers.

The invention has been described above in an NoC implementation. Other types of Dataflow architecture may nevertheless be used.

1. A processing method in a convolutional neural network accelerator comprising an array of unitary processing blocks, each unitary processing block comprising a router and a unitary computing element PE associated with a set of respective local memories, the unitary computing element making it possible to perform computing operations from among multiplications and accumulations on data stored in its local memories, the router making it possible to carry out multiple independent data routing operations in parallel to separate outputs of the router, said method comprising the following steps carried out in parallel by one and the same unitary processing block during one and the same respective processing cycle clocked by a clock of the accelerator:
receiving and/or transmitting, through the router of the unitary block, first and second data from or to neighbouring unitary blocks in the array in first and second directions selected, on the basis of said data, from among at least the vertical and horizontal directions in the array;
the elementary computing unit performing one of said computing operations in relation to data stored in said set of local memories during at least one previous processing cycle.

2. The processing method according to claim 1, wherein said router comprises a block of parallel routing controllers, a block of parallel arbitrators, a block of parallel switches and a block of parallel input buffers, the router being able to receive and process various data communication requests in parallel.

3. The processing method according to claim 1, wherein said accelerator comprises a global control block, a computing control block and a communication control block, the communication control is performed independently of the computing control, the computing controller making it possible to control the computing operations carried out by the unitary computing elements, and the read and write operations from and to the associated local memories, the communication controller managing the data transfers between a global memory and the local memories, and the data transfers between the processing blocks.

4. The processing method according to claim 1, wherein a unitary block performs transmission of a type selected between broadcast and multicast on the basis of a header of the packet to be transmitted and wherein the unitary block applies at least one of said rules:
for a packet to be transmitted in broadcast mode from a neighbouring unitary block located in a given direction with respect to said block having to perform the transmission, said block transmits the packet in the course of a cycle in all directions except for that of said neighbouring block;
for a packet to be transmitted in multicast mode: if the packet comes from the PE of the unitary block, the multicast implemented by the block is bidirectional in two opposite directions; if not, the multicast implemented by the block is unidirectional, directed opposite to the neighbouring processing block from which said packet originates.

5. The processing method according to claim 1, wherein, in the case of at least two simultaneous transmission requests in one and the same direction by a unitary block during a processing cycle, the priority between said requests is arbitrated, the request arbitrated as having priority is transmitted in said direction and the other request is stored and then transmitted in said direction in a subsequent processing cycle.

6. A convolutional neural accelerator comprising an array of unitary processing blocks and a clock, each unitary processing block comprising a router and a unitary computing element PE associated with a set of respective local memories, the unitary computing element making it possible to perform computing operations from among multiplications and accumulations on data stored in its local memories, the router being designed to carry out multiple independent data routing operations in parallel to separate outputs of the router,
wherein one and the same unitary processing block of the array is designed, during one and the same processing cycle clocked by the clock of the accelerator, to:
receive and/or transmit, through the router of the unitary block, first and second data from or to neighbouring unitary blocks in the array in first and second directions selected, on the basis of said data, from among at least the vertical and horizontal directions in the array;
perform one of said computing operations in relation to data stored in their set of local memories during at least one previous processing cycle.

7. The convolutional neural accelerator according to claim 6, wherein said router comprises a block of parallel routing controllers, a block of parallel arbitrators, a block of parallel switches and a block of parallel input buffers, the router being able to receive and process various data communication requests in parallel.

8. The convolutional neural accelerator according to claim 6, comprising a global control block, a computing control block and a communication control block, the communication control is performed independently of the computing control, the computing controller making it possible to control the computing operations carried out by the unitary computing elements, and the read and write operations from and to the associated local memories, the communication controller managing the data transfers between a global memory and the local memories, and the data transfers between the processing blocks.

9. The convolutional neural accelerator according to claim 6, wherein a unitary block is designed to perform transmission of a type selected between broadcast and multicast on the basis of a header of the packet to be transmitted and the unitary block is designed to apply at least one of said rules:
for a packet to be transmitted in broadcast mode from a neighbouring block located in a given direction with respect to said block having to perform the transmission, said block transmits the packet in the course of a cycle in all directions except for that of said neighbouring block;
for a packet to be transmitted in multicast mode: if the packet comes from the PE of the unitary block, the multicast implemented by the block is bidirectional in two opposite directions; if not, the multicast implemented by the block is unidirectional, directed opposite to the neighbouring processing block from which said packet originates.

10. The convolutional neural accelerator according to claim 6, wherein, in the case of at least two simultaneous transmission requests in one and the same direction by a unitary block during a processing cycle, the routing block of the unitary block is designed to arbitrate priority between said requests, the request arbitrated as having priority then being transmitted in said direction and the other request being stored and then transmitted in said direction in a subsequent processing cycle.
